(19) United States
(12) Patent Application Publication
(10) Pub. No.: US 2020/0373545 A1
(43) Pub. Date: Nov. 26, 2020

(54) BATTERY CELL ASSEMBLY AND ELECTROCHEMICAL DEVICE

(71) Applicant: NINGDE AMPEREX TECHNOLOGY LIMITED, Ningde City (CN)

(72) Inventor: Fanxin QUAN, Ningde City (CN)

(21) Appl. No.: 16/668,752

(22) Filed: Oct. 30, 2019

(30) Foreign Application Priority Data
May 21, 2019 (CN) 201910422733.7

(51) Int. Cl. H01M 2/26; H01M 10/0587; H01M 2/10

(52) U.S. Cl. CPC H01M 2/263; H01M 2/1061; H01M 10/0587

(57) ABSTRACT

The present application relates to a battery cell assembly and an electrochemical device. The battery cell assembly includes: a first battery cell, including a first wound electrode assembly; and a second battery cell, including a second wound electrode assembly. The outermost circumference of the first wound electrode assembly is electrically connected with the outermost circumference of the second wound electrode assembly, wherein the first battery cell and the second battery cell form a stepped structure.

### CROSS REFERENCE TO RELATED APPLICATIONS

The present application claims the benefit of priority from the China Patent Application No. 201910422733.7, filed on 21 May 2019, the disclosure of which is hereby incorporated by reference in its entirety.

### BACKGROUND OF THE INVENTION

### 1. Field of the Invention

The present application relates to the technical field of electrochemical devices, and more particularly to a battery cell assembly and an electrochemical device having the same.

### 2. Description of the Related Art

At present, electronic information technologies develop rapidly, and various electronic devices are integrated to an ever-increasing degree and weight and volume thereof are being continuously reduced. In order to prolong the service time of a device through the increase of battery capacity within a certain size, the main approach is to increase the energy density.

### SUMMARY OF THE INVENTION

Some embodiments of the present application provide a battery cell assembly and an electrochemical device. An irregularly-shaped step structure is directly formed by winding, and high safety risk caused by complex trimming process, limited structure and transfer welding is effectively solved.

According to some embodiments of the present application, a battery cell assembly includes: a first battery cell, including a first electrode assembly and formed by winding the first electrode assembly; and a second battery cell, including a second electrode assembly and formed by winding the second electrode assembly. The outermost circumference of the first electrode assembly is electrically connected with the outermost circumference of the second electrode assembly, and the first battery cell and the second battery cell form a step structure.

According to some embodiments of the present application, the first electrode assembly is welded to the second electrode assembly.

According to some embodiments of the present application, the first electrode assembly and the second electrode assembly form a group of electrode assembly, the first battery cell and the second battery cell are formed by winding the group of electrode assembly, and the group of electrode assembly includes a first end and a second end, the first end being located at the inner of the first battery cell and the second end being located at the inner of the second battery cell.

According to some embodiments of the present application, the first battery cell and the second battery cell have different axle centers.

According to some embodiments of the present application, a winding direction for forming the first battery cell is the same as a winding direction for forming the second battery cell, or, the winding direction for forming the first battery cell is opposite to the winding direction for forming the second battery cell, the winding direction being a clockwise direction or a counterclockwise direction.

According to some embodiments of the present application, the first battery cell and the second battery cell are different in dimension.

According to some embodiments of the present application, the width of the first battery cell is different from the width of the second battery cell, and the length of the first battery cell is the same as the length of the second battery cell.

According to some embodiments of the present application, the width of the first battery cell is the same as the width of the second battery cell, and the length of the first battery cell is different from the length of the second battery cell.

According to some embodiments of the present application, the width of the first battery cell is different from the width of the second battery cell, and the length of the first battery cell is different from the length of the second battery cell.

According to some embodiments of the present application, the first battery cell is stacked on the second battery cell, one side of the first battery cell in a width direction is aligned with one side of the second battery cell in the width direction, and one side of the first battery cell in a length direction is aligned or not aligned with one side of the second battery in the length direction.

According to some embodiments of the present application, the length of the first battery cell is smaller than the length of the second battery cell and the width of the first battery cell is less than or equal to the width of the second battery cell, or the width of the first battery cell is smaller than the width of the second battery cell and the length of the first battery cell is less than or equal to the length of the second battery cell.

According to some embodiments of the present application, the first battery cell is stacked on the second battery cell, and the first battery cell and the second battery cell are stacked to form a cross-shaped structure or a T-shaped structure.

According to some embodiments of the present application, the battery cell assembly further includes a connecting component, the outermost circumference of the first electrode assembly is electrically connected with the outermost circumference of the second electrode assembly through the connecting component, and the connecting component includes a collector without being coated an active material and a separator.

According to some embodiments of the present application, each of the first electrode assembly and the second electrode assembly includes an anode plate, a cathode plate, and a separator. The separator is arranged between the anode plate and the cathode plate to separate the anode plate from the cathode plate.

According to some embodiments of the present application, the axis of the first battery cell is parallel with or perpendicular to the axis of the second battery cell.

According to some embodiments of the present application, an electrochemical device includes the abovementioned battery cell assembly.

### BRIEF DESCRIPTION OF THE DRAWINGS

The following will briefly illustrate the accompanying drawings necessary to describe the embodiments of the present application or the existing technology so as to facilitate the description of the embodiments of the present application. Obviously, the accompanying drawings described below are only part of the embodiments of the present application. For those skilled in the art, the accompanying drawings of other embodiments can still be obtained according to the structures illustrated in the accompanying drawings without any creative effort.

FIGS. 1-3, 8, 12, 15, and 18 are structure diagrams of an electrode assembly according to some embodiments of the present application.

FIGS. 4-5, 9, 13, 16, and 19 are structure diagrams of a battery cell assembly according to some embodiments of the present application.

FIGS. 6-7, 10-11, 14, 17, and 20-21 are structure diagrams of a battery according to some embodiments of the present application.

### EMBODIMENTS OF THE PRESENT INVENTION

Embodiments of the present application are described in detail below. Throughout the specification, the same or similar components and components having the same or similar functions are denoted by similar reference numerals. The embodiments described herein with respect to the accompanying drawings are illustrative and graphical, and are used for providing a basic understanding on the present application. The embodiments of the present application should not be construed as limiting the present application.

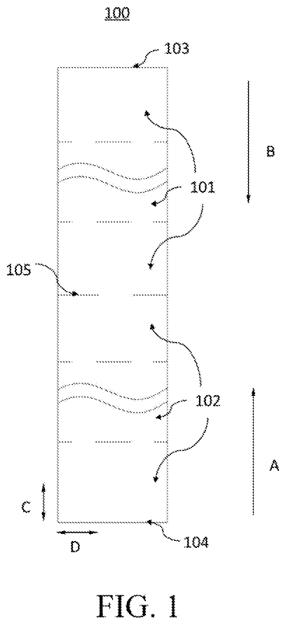

FIGS. 1-3 are structure diagrams of an electrode assembly 100 according to some embodiments of the present application. The electrode assembly 100 includes an electrode assembly 101 and an electrode assembly 102. According to the embodiments of the present application, each of the electrode assembly 101 and the electrode assembly 102 includes an anode plate, a cathode plate, and a separator. The separator is arranged between the anode plate and the cathode plate to separate the anode plate from the cathode plate.

In some embodiments of the present application, the electrode assembly 100 is an integrally formed electrode assembly, and the electrode assembly 101 and the electrode assembly 102 so named are for identification purpose only, which are configured to be respectively wound to form battery cells of the integrally formed electrode assembly. In some embodiments of the present application, the electrode assembly 101 and the electrode assembly 102 are two separate electrode assemblies, and the electrode assembly 100 is formed by welding the electrode assembly 101 and the electrode assembly 102. In some embodiments of the present application, the electrode assembly 100 is formed with other structures, and is not limited to the above structures.

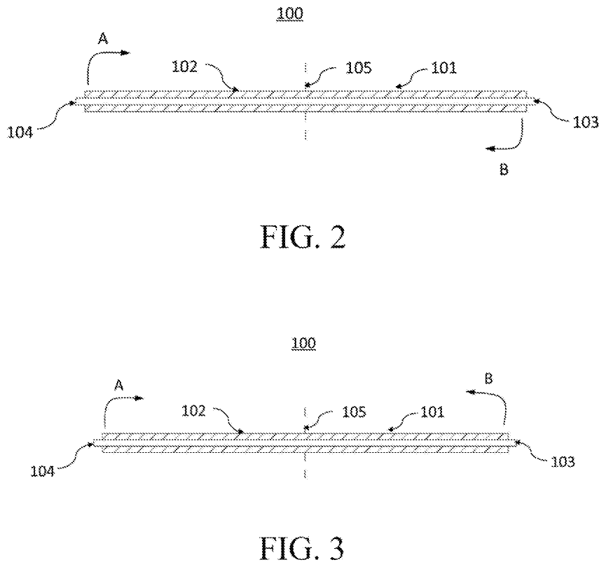

In some embodiments of the present application, the electrode assembly 100 is wound from an end 103 of the electrode assembly 101 and an end 104 of the electrode assembly 102 to a junction 105 of the two electrode assemblies 101, 102. In some embodiments, the junction 105 is the middle of the integrally formed electrode assembly 100, or is a weld portion of two separate electrode assemblies. In some embodiments, a winding direction A is the same as a winding direction B, as shown in FIG. 2. In some embodiments, the winding direction A is opposite to the winding direction B, as shown in FIG. 3. In some embodiments, the winding direction is a clockwise direction, for example, the winding direction A and winding direction B in FIG. 2 and the winding direction A in FIG. 3. In some embodiments, the winding direction is a counterclockwise direction, for example, the winding direction B in FIG. 3. In the electrode assembly 100 shown in FIG. 1, C represents a width direction of the electrode assembly 101 or a width direction of the electrode assembly 102 which is the width direction defined based on the width of a battery cell assembly (not shown), and D represents a length direction of the electrode assembly 101 or a length direction of the electrode assembly 102, which is the length direction defined based on the length of the battery cell assembly (not shown).

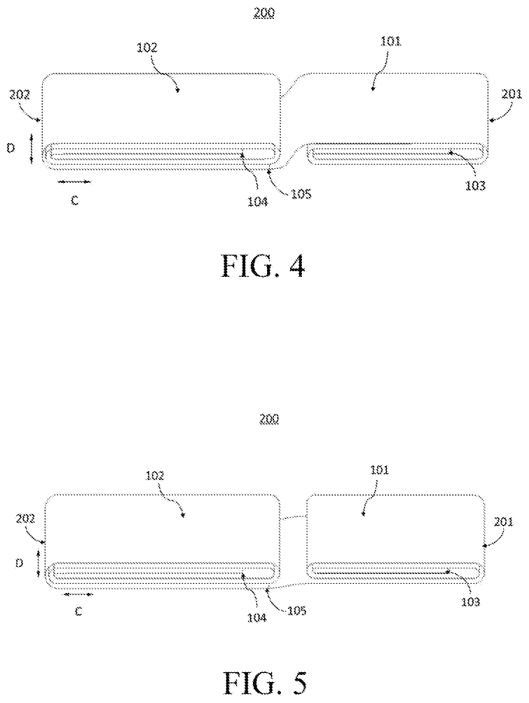

FIG. 4 is a structure diagram of a battery cell assembly 200 according to some embodiments of the present application. The battery cell assembly 200 in FIG. 4 is formed by winding the electrode assembly 100 in FIG. 2. The battery cell assembly 200 includes a battery cell 201 and a battery cell 202. The battery cell 201 includes an electrode assembly 101, and as shown in FIG. 2, wherein the electrode assembly 101 is wound from the end 103 of the electrode assembly 101 to the junction 105 in the clockwise direction to form the battery cell 201. The battery cell 202 includes an electrode assembly 102, and as shown in FIG. 2, the electrode assembly 102 is wound from the end 104 of the electrode assembly 102 to the junction 105 in the counterclockwise direction to form the battery cell 202. The outermost circumference of the wound electrode assembly 101 is electrically connected with the outermost circumference of the would electrode assembly 102. The electrode assembly 101 and the electrode assembly 102 before the windings are regular electrode assemblies. However, the radius of the wound electrode assembly 101 that forms the battery cell 201 is different from the radius of the wound electrode assembly 102 that forms the battery cell 202. Accordingly, the battery cell 201 and the battery cell 202 form a stepped structure; the battery cell 201 and the battery cell 202 have different axes.

FIG. 5 is a structure diagram of a battery cell assembly 200 according to some embodiments of the present application. The battery cell assembly 200 in FIG. 5 is formed by winding the electrode assembly 100 in FIG. 3. The battery cell assembly 200 includes a battery cell 201 and a battery cell 202. The battery cell 201 includes an electrode assembly 101, and as shown in FIG. 3, the electrode assembly 101 is wound from the end 103 of electrode assembly 101 to the junction 105 in the counterclockwise direction to form the battery cell 201. The battery cell 202 includes an electrode assembly 102, and as shown in FIG. 3, the electrode assembly 102 is wound from the end 104 of the electrode assembly 102 to the junction 105 in the clockwise direction to form the battery cell 202. The outermost circumference of the wound electrode assembly 101 is electrically connected with the outermost circumference of the wound electrode assembly 102. The battery cell 201 and the battery cell 202 form a stepped structure. The battery cell 201 and the battery cell 202 have different axes.

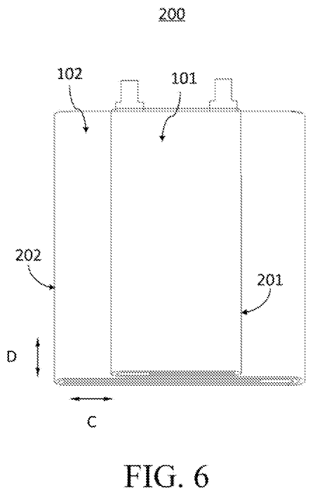

FIG. 6 is a structure diagram of a battery cell assembly 200 according to some embodiments of the present application. The battery cell assembly 200 includes a battery cell 201 and a battery cell 202. The battery cell 201 includes an electrode assembly 101, and the battery cell 201 is formed by winding the electrode assembly 101. The battery cell 202 includes an electrode assembly 102, and the battery cell 202 is formed by winding the electrode assembly 102. The outermost circumference of the wound electrode assembly 101 is electrically connected with the outermost circumference of the wound electrode assembly 102. The battery cell 201 is stacked on the battery cell 202 to form a stepped structure. The length of the battery cell 201 is the same as the length of the battery cell 202. The width of the battery cell 201 is different from the width of the battery cell 202. As shown in FIG. 6, the width of the battery cell 201 is smaller than the width of the battery cell 202. In FIGS. 4-6, the direction D is the direction where the length of the battery cell 201 or the length of the battery cell 202, i.e., the length direction, and the direction C is the direction where the width of the battery cell 201 or the width of the battery cell 202, i.e., the width direction. The length direction of the battery cell 201 or the battery cell 202 is a direction parallel to the winding axis of the battery cell assembly 200, and the width direction of the battery cell 201 or the battery cell 202 is a direction perpendicular to the winding axis of the battery cell assembly 200.

The battery cell assembly 200 in FIG. 6 is similarly formed by winding the electrode assembly 100. The electrode assembly 100 includes an electrode assembly 101 and an electrode assembly 102. The battery cell 201 and the battery cell 202 in FIG. 6 are formed by winding the electrode assembly 101 and the electrode assembly 102 in the same direction, or, the battery cell 201 and the battery cell 202 are formed by winding the electrode assembly 101 and the electrode assembly 102 in opposite directions. It is to be noted that a winding radius for winding the electrode assembly 101 to form the battery cell 201 is different from a winding radius for winding the electrode assembly 102 to form the battery cell 202, thereby forming the stepped structure shown in FIG. 6. In FIG. 6, the length of the battery cell 201 is equal to the length of the battery cell 202, and the width of the battery cell 201 is smaller than the width of the battery cell 202.

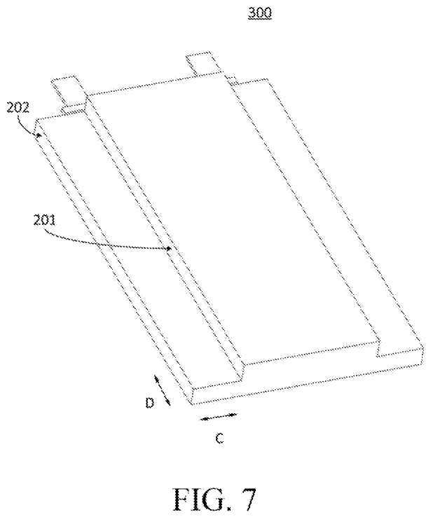

FIG. 7 is a battery 300 formed by the battery cell assembly 200 in FIG. 6. The battery 300 is formed by integrally packaging the battery cell assembly 200, and the battery 300 includes a pair of tabs. In some embodiments, the pair of tabs are welded onto the anode plate and cathode plate of the battery cell 201 respectively. In some embodiments, the pair of tabs are welded onto the anode plate and cathode plate of the battery cell 202 respectively. In some embodiments, the pair of tabs are welded onto the anode plate of the battery cell 201 and the cathode plate of the battery cell 202 respectively. In some embodiments, the pair of tabs are welded onto the cathode plate of the battery cell 201 and the anode plate of the battery cell 202 respectively. Since the battery cell 201 is electrically connected with the battery cell 202, only one pair of tabs need to be disposed and no transfer welding is required, so that the process is simplified, and meanwhile, the problems of burrs and the like caused by transfer welding of the tabs are solved. In FIG. 7, the length of the battery cell 201 is the same as the length of the battery cell 202, and the width of the battery cell 201 is smaller than the width of the battery cell 202. The battery cell 202 is stacked on the battery cell 201.

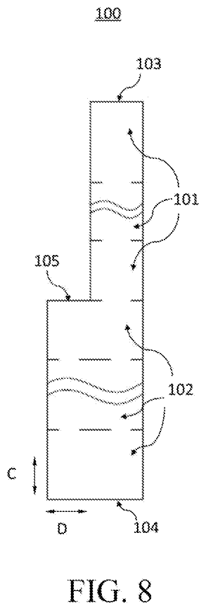

FIG. 8 is a structure diagram of an electrode assembly 100 according to some embodiments of the present application. In FIG. 8, the electrode assembly 100 includes an electrode assembly 101 and an electrode assembly 102, and the length direction of the electrode assembly 100 is perpendicular to a width direction. The length of the electrode assembly 101 is smaller than the length of the electrode assembly 102, and the width of the electrode assembly 101 is smaller than the width of the electrode assembly 102. The right side of the electrode assembly 101 is aligned with the right side of the electrode assembly 102.

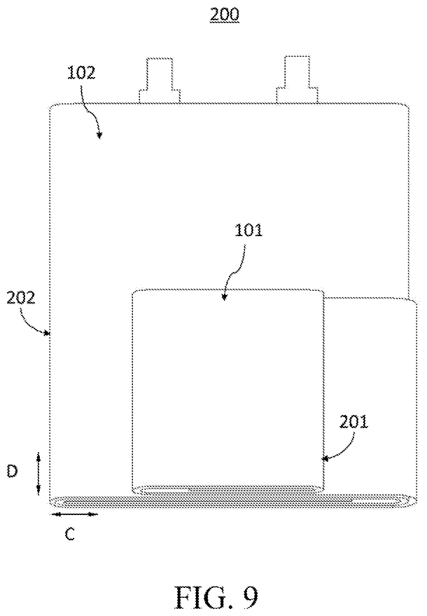

FIG. 9 is a structure diagram of a battery cell assembly 200 according to some embodiments of the present application. The battery cell assembly 200 in FIG. 9 is formed by winding the electrode assembly 100 in FIG. 8. As shown in FIG. 8, the electrode assembly 101 is wound from an end 103 of electrode assembly 101 to a junction 105 to form a battery cell 201, and the electrode assembly 102 is wound from an end 104 of electrode assembly 102 to the junction 105 to form a battery cell 202. The battery cell 201 and the battery cell 202 form a stepped structure. The length of the battery cell 201 is smaller than the length of the battery cell 202, and the width of the battery cell 201 is smaller than the width of the battery cell 202. A side of the battery cell 201 is aligned with a corresponding side of the battery cell 202.

In some other embodiments of the present application, when the same winding radius is adopted to wind the electrode assembly 101 and electrode assembly 102 in FIG. 8 respectively, the battery cell 201 and the battery cell 202 with the same width and different lengths are formed, the length of the battery cell 201 is smaller than the length of the battery cell 202, and the width of the battery cell 201 is equal to the width of the battery cell 202, so that the battery cell 201 is stacked on the battery cell 202 to form the stepped structure, and the battery 300 in such a dimension is formed by an integral packaging. The widths of the battery cell 201 and the battery cell 202 are determined by the winding radii for winding the electrode assembly 101 and the electrode assembly 102.

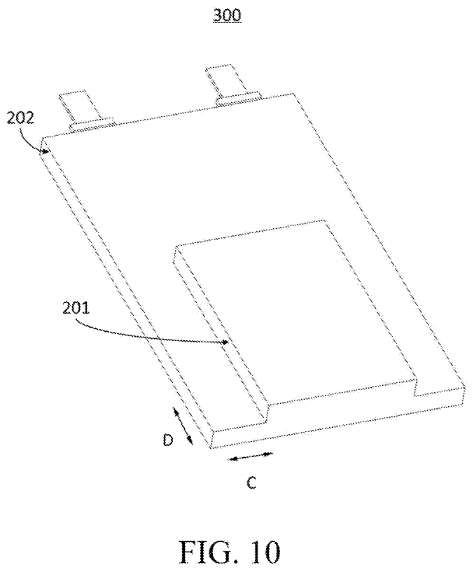

FIG. 10 is a structure diagram of a battery 300 according to some embodiments of the present application. The battery 300 in FIG. 10 is formed by integrally packaging the battery cell assembly 200 in FIG. 9. As shown in FIG. 10, a side of the battery cell 201 in the width direction is aligned with a corresponding side of the battery cell 202 in the width direction, and a side of the battery cell 201 in the length direction is not aligned with either side of the battery cell 202 in the length direction. The battery cell 201 is stacked on the battery cell 202.

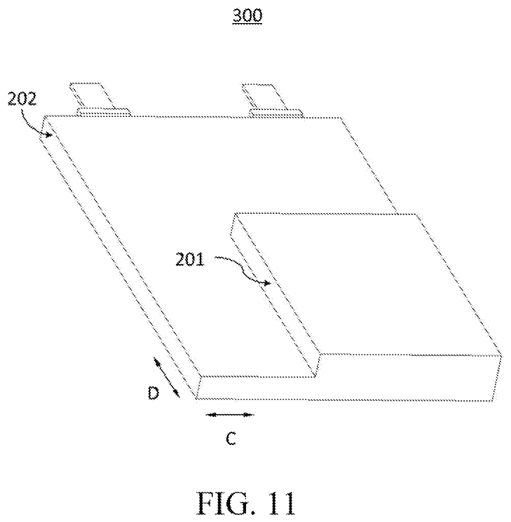

FIG. 11 is a structure diagram of a battery 300 according to some embodiments of the present application. As shown in FIG. 11, a side of the battery cell 201 in the width direction is aligned with a corresponding side of the battery cell 202 in the width direction, and a side of the battery cell 201 in the length direction is aligned with a corresponding side of the battery cell 202 in the length direction. The battery cell 201 is stacked on the battery cell 202. The battery 300 in FIG. 11 is also formed by winding and integrally packaging the electrode assembly 100 in FIG. 8. It should be noted that a winding manner for the electrode assembly 100 during formation of the battery 300 in FIG. 11 is slightly different from a winding manner for forming the battery 300 in FIG. 10, and the former is specifically explained as follows: when winding the electrode assembly 100, through changing the winding radii for the electrode assembly 101 and the electrode assembly 102, a side of the formed battery cell 201 in the width direction is aligned with a corresponding side of the battery cell 202 in the width direction and a side of the battery cell 201 in the length direction is aligned with a corresponding side of the battery cell 202 in the length direction, so that the battery cell 201 is stacked on the battery cell 202 to form the stepped structure. That is, the winding manner for the electrode assembly 100 during formation of the battery 300 in FIG. 11 is different from the winding manner for forming the battery 300 in FIG. 10 in the winding radii for the electrode assembly 101 and electrode assembly 102 shown in FIG. 8. It should be noted that changing the winding radius is not the only way to make the difference. In some embodiments, an electrode assembly different from the electrode assembly 100 shown in FIG. 8 can be adopted to form the battery 300 in FIG. 11, which is determined according to the actual situation.

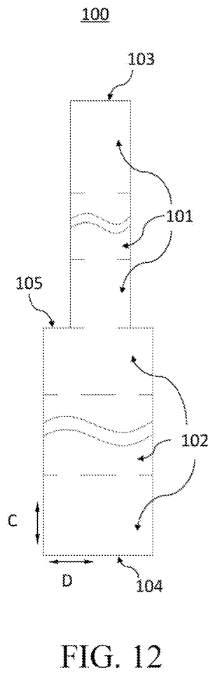

FIG. 12 is a structure diagram of an electrode assembly 100 according to some embodiments of the present application. The electrode assembly 100 is formed by an electrode assembly 101 and an electrode assembly 102. A length direction D of the electrode assembly 101 is perpendicular to a width direction C thereof, which are defined based on the length and width of a battery cell assembly (not shown). The length of the electrode assembly 101 is smaller than the length of the electrode assembly 102, and the width of the electrode assembly 101 is larger than the width of the electrode assembly 102. Any side of the electrode assembly 101 is not aligned any side of the electrode assembly 102.

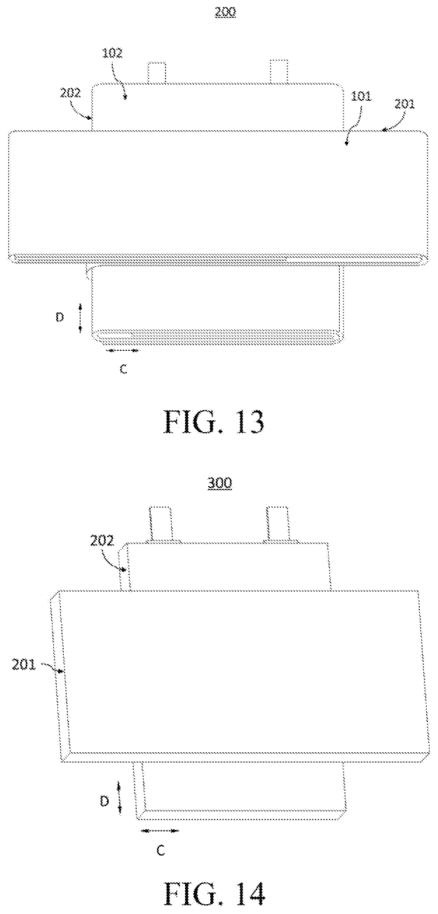

FIG. 13 is a structure diagram of a battery cell assembly 200 according to some embodiments of the present application. The battery cell assembly 200 in FIG. 13 is formed by winding the electrode assembly 100 in FIG. 12. As shown in FIG. 12, the electrode assembly 101 is wound from an end 103 of the electrode assembly 101 to a junction 105 to form a battery cell 201, and the electrode assembly 102 is wound from an end 104 of the electrode assembly 102 to the junction 105 to form a battery cell 202. The battery cell 201 and the battery cell 202 form a cross-shaped structure. The length of the battery cell 201 is smaller than the length of the battery cell 202, and the width of the battery cell 201 is larger than the width of the battery cell 202.

In some embodiments of the present application, the electrode assembly 100 in FIG. 12 is wound to form a battery cell assembly (not shown in the figure) of a T-shaped structure with a single side protruding.

FIG. 14 is a structure diagram of a battery 300 according to some embodiments of the present application. The battery 300 in FIG. 14 is formed by integrally packaging the battery cell assembly 200 in FIG. 13. As shown in FIG. 14, the length of the battery cell 201 is smaller than the length of the battery cell 202, and the width of the battery cell 201 is larger than the width of the battery cell 202, so that the battery of the cross-shaped structure is formed. In some embodiments of the present application, the battery cell 201 and the battery cell 202 also form the battery cell assembly (not shown in the figure) of a T-shaped structure.

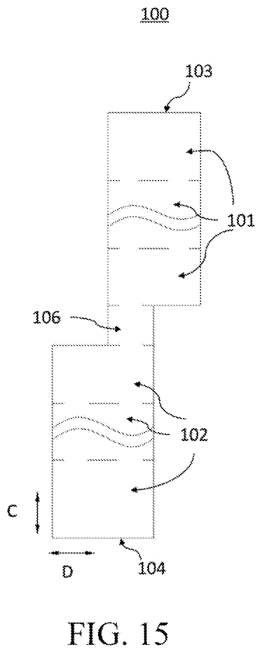

FIG. 15 is a structure diagram of an electrode assembly 100 according to some embodiments of the present application. The electrode assembly 100 includes an electrode assembly 101, an electrode assembly 102 and an electrode assembly 106. The electrode assembly 106 is located between the electrode assembly 101 and the electrode assembly 102, and is configured to connect the electrode assembly 101 with the electrode assembly 102 to form the electrode assembly 100. One side of the electrode assembly 101 in a length direction D is connected with one side of the electrode assembly 106 in the length direction D, and one side of the electrode assembly 102 in the length direction D is connected with another side of the electrode assembly 106 in the length direction D. The electrode assembly 101, the electrode assembly 106 and the electrode assembly 102 integrally form the electrode assembly 100. The length of the electrode assembly 106 is smaller than the lengths of the electrode assembly 101 or the electrode assembly 102. In FIGS. 8, 12 and 15, the direction D refers to the lengthwise direction of the battery cell 201 or the battery cell 202, and the direction C refers to the width direction of the battery cell 201 or the width direction of the battery cell 202. The length direction of the battery cell 201 or the length direction of the battery cell 202 is a direction parallel to the winding axis of the battery cell assembly 200, and the width direction of the battery cell 201 or the width direction of the battery cell 202 is a direction perpendicular to the winding axis of the battery cell assembly 200.

FIG. 16 is a structure diagram of a battery cell assembly 200 according to some embodiments of the present application. The battery cell assembly 200 in FIG. 16 is formed by winding the electrode assembly 100 in FIG. 15. As shown in FIG. 15, the electrode assembly 101 is wound from an end 103 of the electrode assembly 101 to the electrode assembly 106 to form the battery cell 201, and the electrode assembly 102 is wound from an end 104 of the electrode assembly 102 to the electrode assembly 106 to form the battery cell 202. The battery cell 201 and the battery cell 202 when assembled form a protrusion provided at a corner of a side. The lengths, widths and stacking manner of the battery cell 201 and the battery cell 202 are selected according to a practical condition to form various irregularly-shaped battery cell assembly structures.

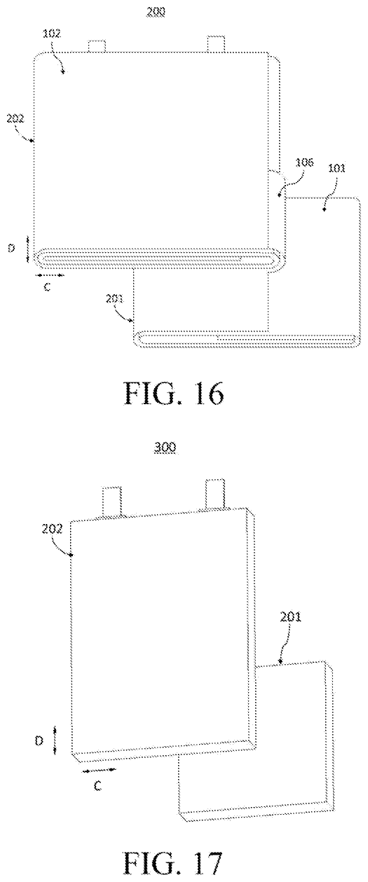

FIG. 17 is a structure diagram of a battery 300 according to some embodiments of the present application. The battery 300 in FIG. 17 is formed by integrally packaging the battery cell assembly 200 in FIG. 16. As shown in FIG. 17, the battery cell 201 and the battery cell 202 when assembled form an irregularly-shaped structure with a protrusion provided at a corners of one side. The lengths, widths and stacking manner of the battery cell 201 and the battery cell 202 are selected according to a practical condition to form various irregularly-shaped battery cell assembly structures.

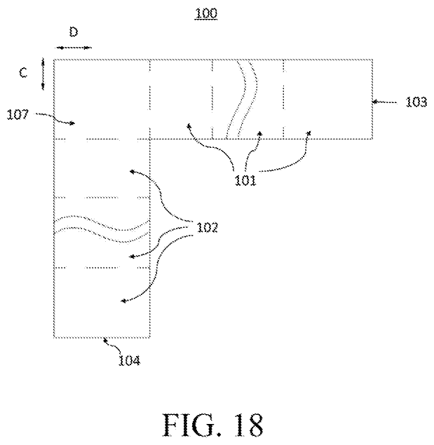

FIG. 18 is a structure diagram of an electrode assembly 100 according to some embodiments of the present application. The electrode assembly 100 includes an electrode assembly 101, an electrode assembly 102 and an electrode assembly 107. The electrode assembly 107 is located between the electrode assembly 101 and the electrode assembly 102, and is configured to connect the electrode assembly 101 with the electrode assembly 102 to form the electrode assembly 100. One side of the electrode assembly 101 in a length direction is connected with one side of the electrode assembly 107, and one side of the electrode assembly 102 in the length direction is connected with another side of the electrode assembly 107. The electrode assembly 101 is perpendicular to the electrode assembly 102. The electrode assembly 101, the electrode assembly 107 and the electrode assembly 102 integrally form the electrode assembly 100. The length of the electrode assembly 101 is equal to the length of the electrode assembly 107, and the length of the electrode assembly 102 is equal to the width of the electrode assembly 107. The direction C represents a width direction of the electrode assembly 101 and a length direction of the electrode assembly 102. The direction D represents a length direction of the electrode assembly 101 and a width direction of the electrode assembly 102. The winding axis of the battery cell 201 is parallel to the direction C, and the winding axis of the battery cell 202 is parallel to the direction D. The direction C is perpendicular to the direction D.

In some embodiments, one side of the electrode assembly 101 in the length direction is connected with one side of the electrode assembly 107 in the width direction, and one side of the electrode assembly 102 in the length direction is connected with one side of the electrode assembly 107 in the length direction. The length of the electrode assembly 101 is equal to the width of the electrode assembly 107, and the length of the electrode assembly 102 is equal to the length of the electrode assembly 107.

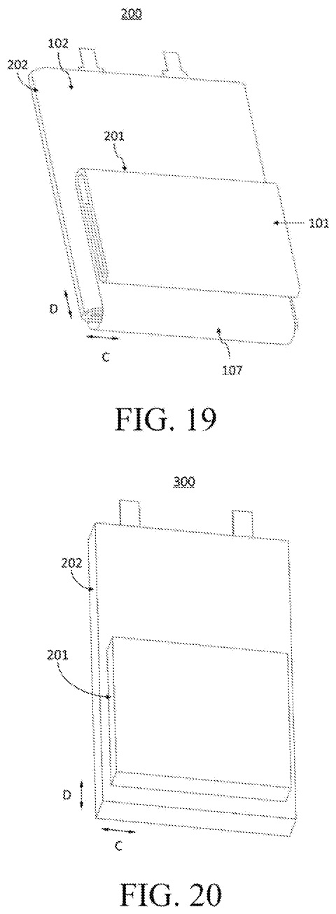

FIG. 19 is a structure diagram of a battery cell assembly 200 according to some embodiments of the present application. The battery cell assembly 200 in FIG. 19 is formed by winding the electrode assembly 100 in FIG. 18. As shown in FIG. 19, the electrode assembly 101 is wound from an end 103 of electrode assembly 101 to the electrode assembly 107 to form the battery cell 201, and the electrode assembly 102 is wound from an end 104 of electrode assembly 102 to the electrode assembly 107 to form the battery cell 202. The battery cell assembly 200 in FIG. 19 is formed by counterclockwise winding. When the width of the anode plate is larger than that of the cathode plate, the anode plate of the electrode assembly 107 is located on the inner side, and the anode plate of the electrode assembly 107 and the electrode assembly avoid short-circuit.

FIG. 20 is a structure diagram of a battery 300 according to some embodiments of the present application. The battery 300 in FIG. 20 is formed by integrally packaging the battery cell assembly in FIG. 19. As shown in FIG. 20, the battery cell 201 is stacked on the battery cell 202.

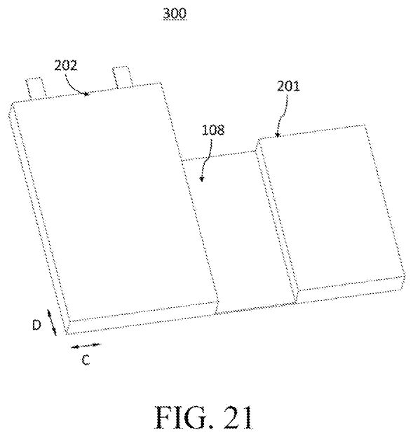

FIG. 21 is a structure diagram of a battery 300 according to some embodiments of the present application. The battery 300 includes a battery cell 201, a battery cell 202, a connecting component 108 and a pair of tabs. The battery cell 201 and the battery cell 202 are laid at an interval of a certain distance, and the battery cell 201 and the battery cell 202 are connected and integrally packaged to form the battery 300 through the connecting component 108.

In some embodiments, an electrode assembly 100 forming the battery 300 shown in FIG. 21 includes an electrode assembly 101, an electrode assembly 102 and the connecting component 108. The electrode assembly 101 is welded to the electrode assembly 102 through the connecting component 108. The length of the electrode assembly 101 is smaller than the length of the electrode assembly 102. The lower side of the electrode assembly 101, the lower side of the connecting component 108 and the lower side of the electrode assembly 102 are aligned. The electrode assembly 101 and the electrode assembly 102 are wound with different winding radii to form the battery cell 201 and the battery cell 202, and the battery cell 201, the connecting component 108 and the battery cell 202 are laid and integrally packaged to form the battery 300 shown in FIG. 21. It is to be noted that the electrode assembly 100 of the battery 300 shown in FIG. 21 is formed by the connecting component 108 which is additionally disposed between the electrode assemblies 101 and 102 shown in FIG. 8.

In some embodiments, the battery 300 shown in FIG. 21 is a strip-type or ribbon flexible battery. The connecting component 108 consists of an active substance-free baseless material and a separator. The connecting component 108 is implemented by forming a single coating on the separator. In some embodiments, the connecting component 108 is an electrode assembly, and the electrode assembly is also expressed as an electrode plate section. In some embodiments, the connecting component 108 is a part of the electrode assembly 102 and a part of the electrode assembly 103. In some embodiments, the pair of tabs are welded onto the anode plate and cathode plate of the battery cell 201 respectively. In some embodiments, the pair of tabs are welded onto the anode plate and cathode plate of the battery cell 202 respectively. In some embodiments, the pair of tabs are welded onto the anode plate of the battery cell 201 and the cathode plate of the battery cell 202 respectively. In some embodiments, the pair of tabs are welded onto the cathode plate of the battery cell 201 and the anode plate of the battery cell 202 respectively. Only one pair of tabs are included, and transfer welding is not required.

Battery cell assemblies 200 of different structures and dimensions are formed by winding electrode assemblies 100 of different structures and dimensions, and batteries 300 of various irregularly-shaped structures are formed by integral packaging. No special process or transfer welding is required to be added, only winding with a winding device for forming is required, and no trimming process is required, so that the process complexity is reduced. In addition, the problems of corrosion and short-circuit and depression of the side edges, caused by transfer welding, of a battery cell finished product are solved. The dimensions of the battery cell 201 and the battery cell 202 are not limited, and the smaller battery cell is placed at any position of the larger battery to form a single-step structure. The battery cell 201 and the battery cell 202 are staggered and stacked to form a multi-step battery cell structure. Instead of being stacked, the battery cell 201 and the battery cell 202 are laid at an interval of a certain distance, connected through the electrode assembly and integrally packaged into a ribbon flexible battery. The battery is formed into an irregular shape to fully utilize the irregular space in a device to achieve the technical effect of improving the energy density without enlarging the dimension of the device and further effectively improving the endurance of the device.

Some embodiments of the present application also provide an electrochemical device, which includes the battery cell assembly 200 in the abovementioned embodiments. In some embodiments, the electrochemical device is the battery 300 of the abovementioned embodiments.

Some embodiments of the present application also provide an electronic device, which includes the battery 300 of the abovementioned embodiments.

References to “some embodiments”, “part of embodiments”, “one embodiment”, “another example”, “example”, “specific example” or “part of examples” in the whole specification mean that at least one embodiment or example in the present application comprises specific features, structures, or characteristics described in the embodiments or examples. Thus, the descriptions appear throughout the specification, such as “in some embodiments”, “in an embodiment”, “in one embodiment”, “in another example”, “in one example”, “in a specific example” or “an example”, which do not necessarily refer to the same embodiment or example in the present application.

Although the illustrative embodiments have been shown and described, it should be understood by those skilled in the art that the above embodiments cannot be interpreted as limiting the present application, and the embodiments can be changed, substituted and modified without departing from the spirit, principle and scope of the present application.

What is claimed is:

1. A battery cell assembly, comprising:
a first battery cell, comprising a first wound electrode assembly; and
a second battery cell, comprising a second wound electrode assembly,
wherein the outermost circumference of the first wound electrode assembly is electrically connected with the outermost circumference of the second wound electrode assembly, and the first battery cell and the second battery cell form a stepped structure.

2. The battery cell assembly according to claim 1, wherein the first wound electrode assembly is welded to the second wound electrode assembly.

3. The battery cell assembly according to claim 1, wherein the first wound electrode assembly and the second wound electrode assembly form a set of electrode assemblies, and the first battery cell and the second battery cell being formed through winding the set of electrode assemblies; and wherein the set of electrode assemblies comprise a first end and a second end, the first end is located at the inner of the first battery cell, and the second end is located at the inner of the second battery cell.

4. The battery cell assembly according to claim 1, wherein the first battery cell and the second battery cell have different axes.

5. The battery cell assembly according to claim 1, wherein a winding direction for forming the first battery cell is the same as a winding direction for forming the second battery cell, or, the winding direction for forming the first battery cell is opposite to the winding direction for forming the second battery cell; and
the winding direction is a clockwise direction or a counterclockwise direction.

6. The battery cell assembly according to claim 1, wherein the first battery cell and the second battery cell are different in dimension.

7. The battery cell assembly according to claim 6, wherein the width of the first battery cell is different from the width of the second battery cell, and/or the length of the first battery cell is different from the length of the second battery cell.

8. The battery cell assembly according to claim 6, wherein the first battery cell is stacked on the second battery cell, a side of the first battery cell in a width direction is aligned with a corresponding side of the second battery cell in the width direction, and a side of the first battery cell in a length direction is aligned or not aligned with a corresponding side of the second battery in the length direction.

9. The battery cell assembly according to claim 8, wherein the length of the first battery cell is smaller than the length of the second battery cell and the width of the first battery cell is less than or equal to the width of the second battery cell, or the width of the first battery cell is smaller than the width of the second battery cell and the length of the first battery cell is less than or equal to the length of the second battery cell.

10. The battery cell assembly according to claim 1, wherein the first battery cell is stacked on the second battery cell, and the first battery cell and the second battery cell are stacked to form a cross-shaped structure or a T-shaped structure.

11. The battery cell assembly according to claim 1, further comprising a connecting component, wherein the outermost circumference of the first electrode assembly is electrically connected with the outermost circumference of the second electrode assembly through the connecting component, and the connecting component comprises a collector without being coated an active material and a separator.

12. The battery cell assembly according to claim 1, wherein each of the first wound electrode assembly and the second wound electrode assembly comprises an anode plate, a cathode plate and a separator, the separator being arranged between the anode plate and the cathode plate to separate the anode plate from the cathode plate.

13. The battery cell assembly according to claim 1, wherein the axis of the first battery cell is parallel or perpendicular to the axis of the second battery cell.

14. An electrochemical device, comprising a battery cell assembly, wherein the battery cell assembly comprises:
a first battery cell, comprising a first wound electrode assembly; and
a second battery cell, comprising a second wound electrode assembly;
wherein the outermost circumference of the first wound electrode assembly is electrically connected with the outermost circumference of the second electrode assembly, wherein the first battery cell and the second battery cell form a stepped structure.

15. The electrochemical device according to claim 14, wherein the first wound electrode assembly and the second wound electrode assembly form a set of electrode assemblies, the first battery cell and the second battery cell are formed of the set of electrode assemblies, and the set of electrode assemblies comprise a first end and a second end, the first end being located at the inner of the first battery cell and the second end being located at the inner of the second battery cell.

16. The electrochemical device according to claim 14, wherein a winding direction for forming the first battery cell is the same as a winding direction for forming the second battery cell, or, the winding direction for forming the first battery cell is opposite to the winding direction for forming the second battery cell, and wherein the winding direction being a clockwise direction or a counterclockwise direction.

17. The electrochemical device according to claim 14, wherein the width of the first battery cell is different from the width of the second battery cell, and/or the length of the first battery cell is different from the length of the second battery cell.

18. The electrochemical device according to claim 14, wherein the first battery cell is stacked on the second battery cell, a side of the first battery cell in a width direction is aligned with a corresponding side of the second battery cell in the width direction, and a side of the first battery cell in a length direction is aligned or not aligned with a corresponding side of the second battery in the length direction.

19. The electrochemical device according to claim 18, wherein the length of the first battery cell is smaller than the length of the second battery cell and the width of the first battery cell is less than or equal to the width of the second battery cell, or the width of the first battery cell is smaller than the width of the second battery cell and the length of the first battery cell is less than or equal to the length of the second battery cell.

20. The electrochemical device according to claim 14, further comprising a connecting component, wherein the outermost circumference of the first electrode assembly is electrically connected with the outermost circumference of the second electrode assembly through the connecting component, and the connecting component comprises a collector without being coated an active material and a separator.
